(19) United States
(12) Patent Application Publication
(10) Pub. No.: US 2019/0204721 A1
(43) Pub. Date: Jul. 4, 2019

(54) IMAGE DISPLAY APPARATUS AND METHOD OF INSTALLING AN IMAGE DISPLAY APPARATUS

(71) Applicant: SONY CORPORATION, TOKYO (JP)

(72) Inventors: RYO KUSUI, KANAGAWA (JP); YOSHITARO SHIMOYAMA, KANAGAWA (JP)

(21) Appl. No.: 16/325,244

(22) PCT Filed: Aug. 10, 2017
(86) PCT No.: PCT/JP2017/029075

§ 371 Date: Feb. 13, 2019

(30) Foreign Application Priority Data
Aug. 30, 2016 (JP) 2016-168340

(51) Int. Cl. G03B 21/14

(52) U.S. Cl. CPC G03B 21/142; G03B 21/145

(57) ABSTRACT

A projector includes a main body, a support structure, and a stability support. The main body projects an image. The support structure abuts on a support surface on which the main body is installed, and supports the main body such that the main body takes a predetermined posture with respect to the support surface. The stability support is provided at a position different from a position of the main support, and abuts on the support surface to hold the posture of the main body supported by the stability support when the main body is exposed to a mechanical disturbance.

### CROSS REFERENCE TO RELATED APPLICATIONS

This application claims the benefit of Japanese Priority Patent Application JP 2016-168340 filed Aug. 30, 2016, the entire contents of which are incorporated herein by reference.

### TECHNICAL FIELD

The present technology relates to an image display apparatus such as a projector and to a method of installing an image display apparatus.

### BACKGROUND ART

When an image is projected with use of a projector, it is necessary to adjust a position or posture of the projector. In particular, in a case where a short focus (or short throw) projector is used, a projected image is moved to a large extent due to a minute positional displacement or the like of the projector. Thus, adjusting the position and posture is important.

In a projector described in Patent Literature 1, three leg portions are provided to the bottom surface of a casing. One fixed leg is provided at substantially the center of the bottom surface on the front side (image projection side), and two leg portions for adjustment are provided at both ends on the rear side. When the leg portions for adjustment are rotated to change the length of each of the leg portions (the amount of protrusion from the bottom surface), the posture of the projector can be adjusted. The leg portions for adjustment have a configuration that makes it easy for a user to operate, to thus facilitate adjustment of the posture. Further, in the leg portions for adjustment, rotation of tip ends that abut on a placing surface is regulated, and only the length is changed. This prevents a positional displacement from occurring when the posture is adjusted (see paragraphs [0032] to [0035], FIG. 3, and the like of the specification of Patent Literature 1).

### CITATION LIST

### Patent Literature

### PTL 1

### Japanese Patent No. 5499624

### SUMMARY

### Technical Problem

The short focus projector will be increasingly diffused, and thus there is a demand for a technology capable of sufficiently preventing rattling or a positional displacement of a projector from occurring.

In view of the circumstances as described above, it is an object of the present technology to provide an image display apparatus and a method of installing an image display apparatus that are capable of sufficiently preventing rattling or a positional displacement from occurring.

### Solution to Problem

According to one embodiment of the present technology, there is provided an image display apparatus including a main body, a support unit, and a holding unit.

The main body projects an image.

The support unit abuts on an installation surface on which the main body is installed, and supports the main body such that the main body takes a predetermined posture with respect to the installation surface.

The holding unit is provided at a position different from a positon of the support unit on the main body, and abuts on the installation surface to hold the posture of the main body supported by the support unit.

In the image display apparatus, the main body is supported to take a predetermined posture by the support unit. Further, the posture of the main body is held by the holding unit that is provided at a position different from a position of the support unit. This makes it possible to sufficiently prevent rattling or a positional displacement of the image display apparatus from occurring.

The support unit may support the main body such that the main body is located at a predetermined position with respect to the installation surface. In this case, the holding unit may hold the position of the main body supported by the support unit.

This makes it possible to sufficiently prevent rattling or a positional displacement of the image display apparatus from occurring.

The holding unit may be configured to be movable from the main body toward the installation surface.

This makes it possible to sufficiently hold the posture and the position of the main body supported by the support unit.

The support unit may include a fixed leg and an adjustable leg, the fixed leg including a fixed tip end at a fixed distance from the main body, the adjustable leg including an adjustable tip end that is movable from the main body toward the installation surface. In this case, the holding unit may include a holding leg, the holding leg including a holding tip end that is movable from the main body toward the installation surface.

When the adjustable leg is operated with the fixed leg being as a reference, it is possible to easily adjust the posture of the main body. Further, it is possible to sufficiently hold the posture of the main body by the holding leg.

The adjustable tip end may have a first hardness. In this case, the holding tip end may have a second hardness that is lower than the first hardness.

This enables the holding tip end to sufficiently come into close contact with the installation surface and makes it possible to sufficiently prevent rattling or a positional displacement from occurring.

The second hardness may be lower than a hardness of the fixed tip end.

This makes it possible to sufficiently prevent rattling or a positional displacement from occurring.

The adjustable tip end may abut on the installation surface to have a first contact area. In this case, the holding tip end may abut on the installation surface to have a second contact area that is larger than the first contact area.

This makes it easy to adjust the posture by the adjustable leg and to sufficiently hold the position and the posture by the holding leg.

The adjustable tip end may have a convex surface that abuts on the installation surface. In this case, the holding tip end may have a flat surface that abuts on the installation surface. This makes it easy to adjust the posture by the adjustable leg and to sufficiently hold the position and the posture by the holding leg.

The adjustable tip end may have a first friction coefficient. In this case, the holding tip end may have a second friction coefficient that is larger than the first friction coefficient. This makes it easy to adjust the posture by the adjustable leg and to sufficiently hold the position and the posture by the holding leg.

The adjustable leg may include a first rotation operation portion that rotates to move the adjustable tip end. In this case, the holding leg may include a second rotation operation portion that rotates to move the holding tip end.

This makes it easy to adjust the posture by the adjustable leg and to cause the holding leg to abut on the installation surface.

The first rotation operation portion may have a first diameter. In this case, the second rotation operation portion may have a second diameter that is smaller than the first diameter. This makes it easy to rotate the adjustable leg and to prevent an unnecessary torque from being applied to the holding leg abutting on the installation surface.

The adjustable leg may include a first holding unit and a second holding unit, the first holding unit holding the adjustable tip end, the second holding unit holding the first holding unit to be movable from the main body toward the installation surface. In this case, the holding leg may include a third holding unit and a fourth holding unit, the third holding unit holding the holding tip end, the fourth holding unit holding the third holding unit to be movable from the main body toward the installation surface.

With this configuration, it is possible to achieve the adjustable leg and the holding leg with a simple configuration.

The second holding unit may rotate to move the first holding unit. In this case, the fourth holding unit may rotate to move the third holding unit.

This makes it easy to adjust the posture by the adjustable leg and to cause the holding leg to abut on the installation surface.

The second holding unit may have a first diameter. In this case, the fourth holding unit may have a second diameter that is smaller than the first diameter.

This makes it easy to rotate the adjustable leg and to prevent an unnecessary torque from being applied to the holding leg abutting on the installation surface.

The second holding unit may hold the first holding unit by screwing. In this case, the fourth holding unit may hold the third holding unit by screwing.

This makes it easy to operate the adjustable leg and the holding leg.

The main body may include an adjustable-leg holding unit and a holding-leg holding unit, the adjustable-leg holding unit holding the adjustable leg to be movable from the main body toward the installation surface, the holding-leg holding unit holding the holding leg to be movable from the main body toward the installation surface.

With this configuration, it is possible to achieve the adjustable leg and the holding leg with a simple configuration.

The image display apparatus may further include a short focus optical system that is housed in the main body and is capable of projecting the image.

The present technology enables the position and the posture of the short focus projector to be sufficiently held and makes it possible to sufficiently prevent rattling or a positional displacement from occurring.

When the image is projected on a front side and the other side is considered as a rear side, the fixed leg may be provided at one point of a substantially center portion of the main body on the front side. In this case, the adjustable leg may be provided at each of two ends of the main body on the rear side. Further, the holding leg may be provided at each of two ends of the main body on the front side.

With this configuration, it is possible to sufficiently support the image display apparatus at three points of the single fixed leg and the two adjustable legs. Further, it is possible to sufficiently hold the position and the posture of the image display apparatus by the two holding legs.

The holding leg may include a regulation mechanism that regulates rotation of the holding leg when a torque applied to the second rotation operation portion is a predetermined threshold value or larger.

This makes it possible to prevent the holding leg abutting on the installation surface from being rotated more than necessary.

According to another embodiment of the present technology, there is provided a method of installing an image display apparatus, the method including: supporting a main body by a support unit such that the main body takes a predetermined posture with respect to an installation surface, the main body projecting an image, the support unit abutting on the installation surface on which the main body is installed; and holding the posture of the main body supported by the support unit by causing a holding unit to abut on the installation surface, the holding unit being provided at a position different from a position of the support unit on the main body.

### Advantageous Effects

As described above, according to the present technology, it is possible to sufficiently prevent rattling or a positional displacement of an image display apparatus from occurring. It should be noted that the effects described herein are not necessarily limited, and any of the effects described in this disclosure may be produced.

### BRIEF DESCRIPTION OF DRAWINGS

FIG. 1 is a perspective view showing a configuration example of an image display apparatus according to one embodiment of the present technology.

FIG. 2 is a schematic view of the image display apparatus shown in FIG. 1 viewed from above.

FIG. 3 is a perspective view showing a configuration example of a bottom surface of the image display apparatus and a support mechanism provided to the bottom surface.

FIG. 4 is a flowchart showing an example of a method of installing the image display apparatus.

FIGS. 5A and 5B are cross-sectional views respectively showing a configuration example of an adjustable leg and a configuration example of a rattling prevention leg.

FIG. 6 is a cross-sectional view showing a configuration example of a rattling prevention leg according to another embodiment.

FIGS. 7A and 7B are schematic views each showing a configuration example of an adjustable leg according to another embodiment.

FIG. 8 is a schematic view showing a configuration example of an adjustable leg according to another embodiment.

### DESCRIPTION OF EMBODIMENTS

Hereinafter, embodiments of the present technology will be described with reference to the drawings.

### [Image Display Apparatus]

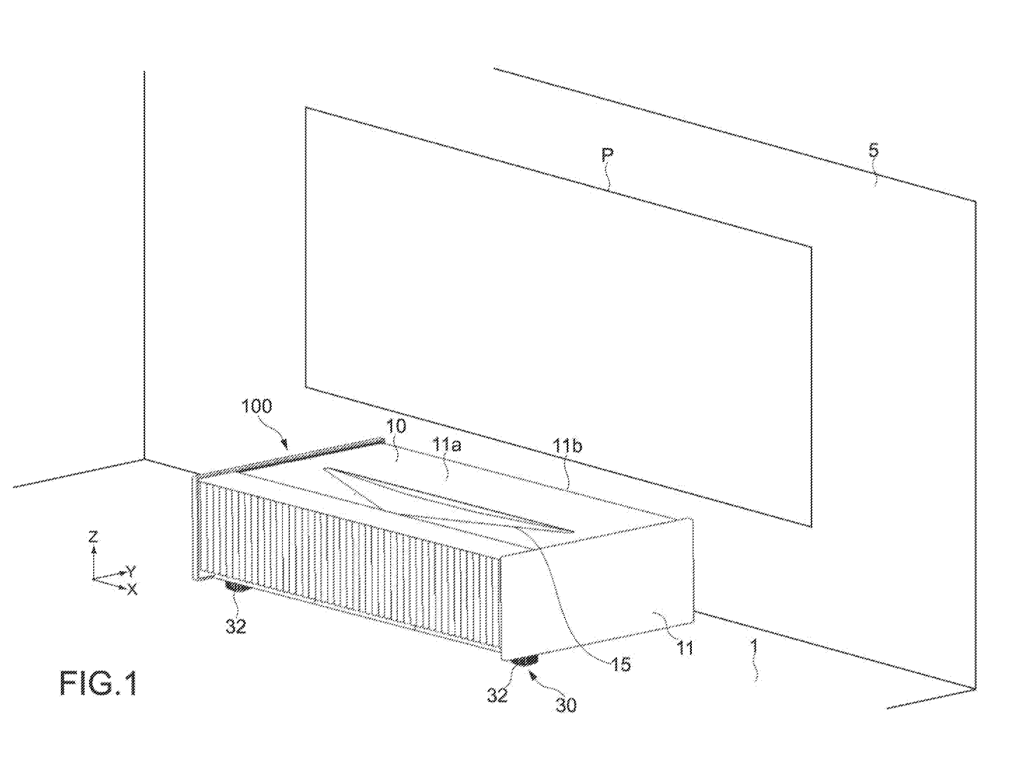

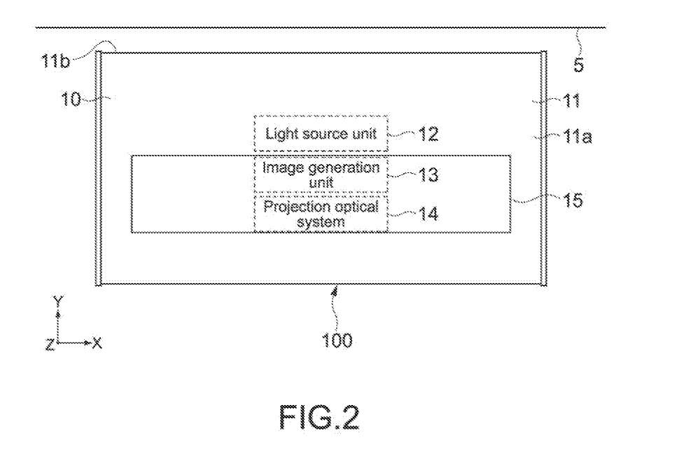

FIG. 1 is a perspective view showing a configuration example of an image display apparatus according to one embodiment of the present technology. FIG. 2 is a schematic view of the image display apparatus viewed from above. FIG. 2 schematically shows an internal configuration of the image display apparatus as well.

In this embodiment, an ultra-short focus (or short throw, which describes a short throw ratio of distance from the projector to screen size 1:1 or lower less, such as 0.6:1) projector capable of projecting an image from a close position is used as an image display apparatus 100. As shown in FIGS. 1 and 2, the image display apparatus 100 includes a main body 10 and a support mechanism 30. The main body 10 projects an image P. The support mechanism 30 supports the main body 10.

The main body 10 includes a casing 11, a light source unit 12, an image generation unit 13, and a projection optical system 14. The light source unit 12, the image generation unit 13, and the projection optical system 14 are housed in the casing 11. The casing 11 has a substantially rectangular parallelepiped shape and includes a projection window 15 on a top surface 11a thereof. It should be noted that the shape of the casing 11 corresponds to the shape of the main body 10.

Hereinafter, it is assumed that the side on which the image P is projected is a front side and the opposite side is a rear side. Therefore, a Y direction shown in FIGS. 1 and 2 is a front-back direction, and an X direction therein is a transverse direction. Further, a Z direction is a height direction.

Further, in this embodiment, description will be given assuming that an installation surface 1 on which the main body 10 is installed is a horizontal surface, that is, an XY-plane direction is equal to a horizontal direction and the Z direction is equal to a vertical direction. However, the present technology is not limited to this embodiment and can also be applied to a case where the installation surface 1 is inclined.

The projection window 15 provided to the top surface 11a is configured to be openable and closable, and is opened when the image P is projected. It should be noted that FIG. 2 shows the projection window 15 by a frame thereof only.

The light source unit 12 generates white light and outputs the white light to the image generation unit 13. For example, a solid-state light source such as a laser light source and a light emitting diode (LED), a mercury lamp, or a xenon lamp is used as the light source unit 12. In order to generate the white light, a phosphor wheel to which phosphor is applied or the like may be used. The phosphor is excited by laser light or the like and generates visible light.

The image generation unit 13 includes light modulation devices such as an illumination optical system and a liquid crystal panel. The illumination optical system divides the white light into color light beams of R, G, and B, and each of the color light beams is guided to a light modulation device for each color. The light modulation devices modulate the respective color light beams of R, G, and B on the basis of image information that is input from the outside. The modulated light beams (image light beams) of the respective colors are synthesized with use of a dichroic prism or the like and output to the projection optical system 14.

The projection optical system 14 is a short focus optical system (also referred to as ultra-short focus optical system) capable of projecting an image from a close position. For example, the projection optical system 14 includes a lens system and a free-form surface mirror. The lens system outputs the generated image light to the free-form surface mirror disposed close to the projection window 15. The image light is reflected on the free-form surface mirror, and thus an image with a wide angle of view (wide-angle image) P is projected toward the front side.

Specific configurations of the light source unit 12, the image generation unit 13, and the projection optical system 14 are not limited and may be appropriately designed.

In this embodiment, the main body 10 (casing 11) has the size of approximately 100 cm in width in the transverse direction, approximately 50 cm in depth in the front-back direction, and approximately 15 cm in height. As a matter of course, the size of the main body 10 is not limited and may be optionally designed.

As shown in FIGS. 1 and 2, the main body 10 is installed on the installation surface 1 such that a front surface 11b of the casing 11 comes close to a projection surface 5. Even if the main body 10 is located at an extremely close range, e.g., at a distance of approximately 5 cm from the projection surface 5, the wide-angle image P can be accurately projected. It should be noted that a position where the main body 10 can be disposed (the distance from the projection surface 5) is not limited.

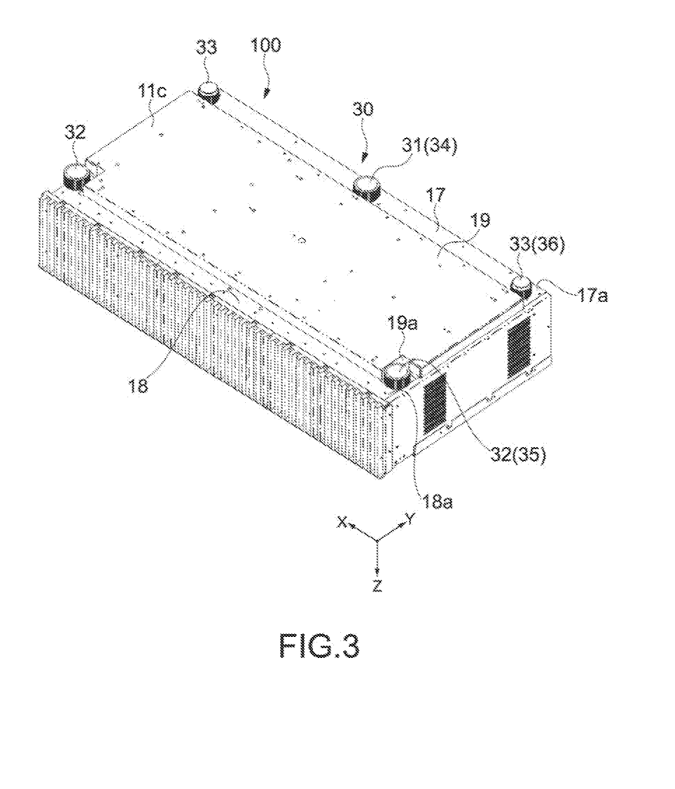

FIG. 3 is a perspective view showing a configuration example of a bottom surface of the image display apparatus 100 and the support mechanism 30 provided to the bottom surface. As shown in FIG. 3, a bottom surface 11c includes a front part 17 formed on the front side along the transverse direction (X direction) and a rear part 18 formed on the rear side along the transverse direction. Further, the bottom surface 11c includes a convex portion 19 that is formed between the front part 17 and the rear part 18 and protrudes downward. There is a level difference between each of the front part 17 and the rear part 18, and the convex portion 19.

When the bottom surface 11c is viewed from the front thereof, each of the front part 17, the rear part 18, and the convex portion 19 has a substantially rectangular shape extending in the transverse direction. More specifically, notches 19a are formed at two corners of the convex portion 19 on the rear side. The portions of the notches 19a form a part of the rear part 18. It should be noted that in this embodiment the bottom surface 11c corresponds to a substantially rectangular opposed surface that faces the installation surface 1.

The support mechanism 30 includes one fixed leg 31, two adjustable legs 32, and two rattling prevention legs 33. The fixed leg 31 is provided at a substantially center portion of the front part 17. The fixed leg 31 is a leg having a fixed length from the bottom surface 11c. In other words, a distance between a tip end (hereinafter, described as fixed tip end) 34 of the fixed leg 31 and the bottom surface 11c of the main body 10 is fixed. It should be noted that the height of the fixed tip end 34 (the distance from the bottom surface 11c) is larger than the height of the level difference of the convex portion 19.

The adjustable legs 32 are respectively provided at two ends 18a of the rear part 18, that is, the portions where the notches 19a of the convex portion 19 are formed. The adjustable legs 32 are configured so as to be movable along the height direction (the Z direction) by being rotated with the height direction being as an axial direction. Therefore, rotating the adjustable leg 32 can change the height (the distance from the bottom surface 11c) of a tip end (hereinafter, described as adjustable tip end) 35 of the adjustable leg 32.

Typically, when the adjustable leg 32 is rotated in a clockwise direction with respect to the bottom surface 11c, the adjustable leg 32 is shortened, that is, the adjustable tip end 35 is moved toward the bottom surface 11c. When the adjustable leg 32 is rotated in a counterclockwise direction, the adjustable leg 32 is elongated, that is, the adjustable tip end 35 is moved toward the installation surface 1. As a matter of course, the rotation direction is not limited.

It should be noted that a state where the adjustable leg 32 is rotated to move the adjustable tip end 35 to the position closest to the bottom surface 11c is assumed as a reference position state. In the reference position state, the height of the adjustable tip end 35 is larger than that of the level difference of the convex portion 19.

The rattling prevention legs 33 are respectively provided at two ends 17a of the front part 17. The rattling prevention legs 33 are configured so as to be movable along the height direction (the Z direction) by being rotated with the height direction being as an axial direction. Therefore, rotating the rattling prevention leg 33 can change the height (the distance from the bottom surface 11c) of a tip end (hereinafter, described as rattling prevention tip end) 36 of the rattling prevention leg 33.

Typically, when the rattling prevention leg 33 is rotated in the clockwise direction with respect to the bottom surface 11c, the rattling prevention leg 33 is shortened, that is, the rattling prevention tip end 36 is moved toward the bottom surface 11c. When the rattling prevention leg 33 is rotated in the counterclockwise direction, the rattling prevention leg 33 is elongated, that is, the rattling prevention tip end 36 is moved toward the installation surface 1. As a matter of course, the rotation direction is not limited.

It should be noted that a state where the rattling prevention leg 33 is rotated to move the rattling prevention tip end 36 to the position closest to the bottom surface 11c is assumed as a reference position state. In the reference position state, the height of the rattling prevention tip end 36 is smaller than that of the level difference of the convex portion 19.

Therefore, in a case where all of the adjustable legs 32 and the rattling prevention legs 33 are set to the reference position states and the main body 10 is installed on the installation surface 1, the main body 10 is supported by the fixed leg 31 and the adjustable legs 32. Then the rattling prevention tip ends 36 are distant from the installation surface 1. It should be noted that the present technology is not limited to this configuration.

### [Method of Installing Image Display Apparatus]

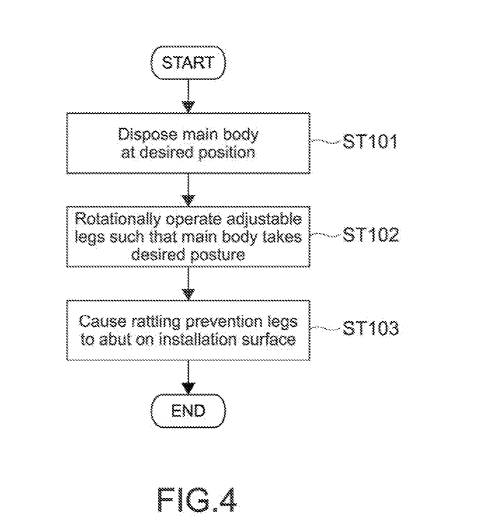

FIG. 4 is a flowchart showing an example of a method of installing the image display apparatus 100. The image display apparatus 100 is installed while visually checking, for example, a position, an inclination, a shape (presence or absence of image distortion), or the like of the image P projected on the projection surface 5.

First, the main body 10 is disposed at a desired position of the installation surface 1 (Step 101). For example, the fixed leg 31 is caused to abut on a position close to the projection surface 5, and the orientation of the main body 10 in the transverse direction is adjusted with the fixed leg 31 being as a reference. When the adjustment is completed, the adjustable legs 32 are caused to abut on the installation surface 1. In a case where the rattling prevention legs 33 abut on the installation surface 1 at that time, the rattling prevention legs 33 are set to the reference position state and the position adjustment is performed again.

Next, the two adjustable legs 32 are each operated such that the main body 10 takes a desired posture (Step 102). For example, while checking a position, an inclination, or the like of the image P, the orientation of the main body 10 in the height direction, an inclination to the right or left, or the like is adjusted. In this embodiment, the adjustable legs 32 are provided at the ends 18a of the main body 10 on the rear side, that is, on the user side. Therefore, the adjustable legs 32 are readily accessible to the user, and the posture of the main body 10 can be adjusted with good operability.

In such a manner, in this embodiment, the position and the posture of the main body 10 are determined by the fixed leg 31 and the adjustable legs 32. The fixed leg 31 and the adjustable legs 32 function as a support unit that supports the main body 10 so as to take a predetermined position and posture with respect to the installation surface 1.

The rattling prevention legs 33 are operated to cause the rattling prevention tip ends 36 to abut on the installation surface 1 (Step 103). With this configuration, the position and the posture of the main body 10 that are determined by the fixed leg 31 and the adjustable legs 32 are held. As a result, a positional displacement and rattling of the main body 10 can be sufficiently prevented from occurring.

### [Adjustable Leg and Rattling Prevention Leg]

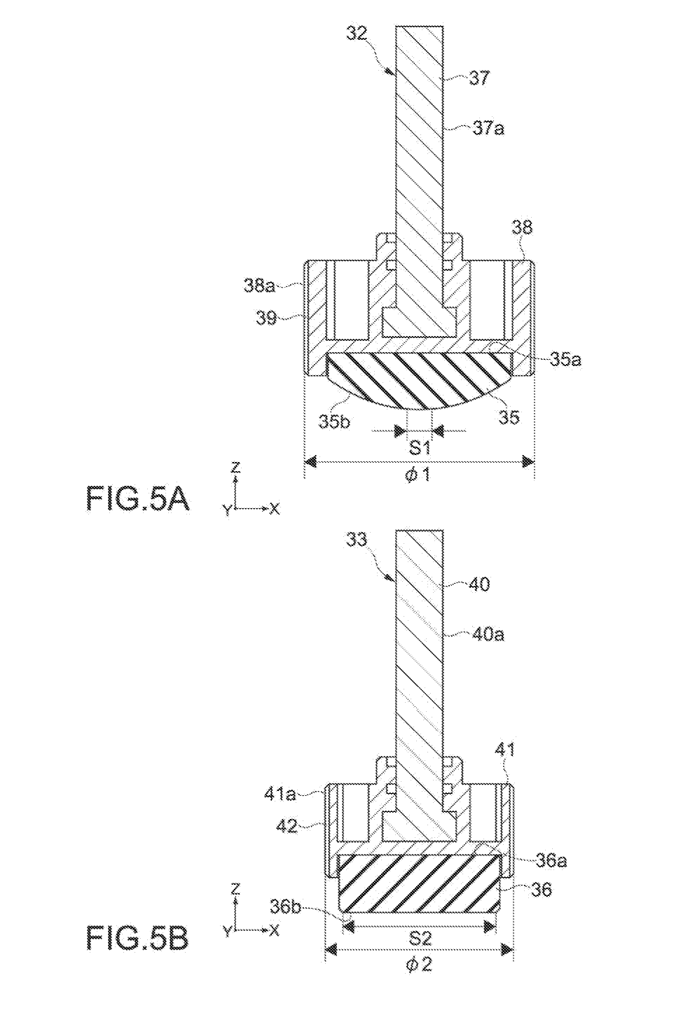

FIGS. 5A and 5B are cross-sectional views respectively showing a configuration example of the adjustable leg 32 and a configuration example of the rattling prevention leg 33. FIG. 5A is the cross-sectional view of the adjustable leg 32, and FIG. 5B is the cross-sectional view of the rattling prevention leg 33.

The adjustable leg 32 includes a screw portion 37, a rotation operation portion (first rotation operation portion) 38, and the adjustable tip end 35. The screw portion 37 has a substantially columnar shape extending in the height direction, and has a side surface 37a on which a screw groove (not shown in the figure) is formed. Screw holes are formed at the ends 18a of the rear part 18 of the main body 10. The screw portion 37 of the adjustable leg 32 is attached to the screw hole by screwing. The screw portion 37 is made of a metal material, for example, iron or aluminum.

The screw holes formed at the ends 18a of the rear part 18 of the main body 10 correspond to an adjustable-leg holding unit that holds the adjustable legs 32 to be movable from the main body 10 toward the installation surface 1.

The rotation operation portion 38 receives an input of a rotation operation from a user. The rotation operation portion 38 has a substantially columnar shape extending in the height direction, and the screw portion 37 is connected to substantially the center thereof on the upper side (the main body 10 side). The screw portion 37 is connected to the rotation operation portion 38 such that the central axes thereof are substantially equal to each other. A connection mode or configuration for connection between the rotation operation portion 38 and the screw portion 37 is not limited and, for example, bonding, fitting, or the like may be appropriately used therefor.

A side surface 38a of the rotation operation portion 38 includes a plurality of grooves 39 extending in the height direction. This can prevent fingers or the like from slipping when pinching the side surface 38a of the rotation operation portion 38. As a result, the adjustable leg 32 can be rotated with good operability and the posture of the main body 10 is easily adjusted. For the rotation operation portion 38, for example, a resin material such as plastic is used.

The adjustable tip end 35 is provided on the lower side (the installation surface 1 side) of the rotation operation portion 38. The adjustable tip end 35 is attached to the rotation operation portion 38 by bonding, for example. As a matter of course, the present technology is not limited thereto, and the rotation operation portion 38 and the adjustable tip end 35 may be integrally formed.

As shown in FIG. 5A, the adjustable tip end 35 has a connection surface 35a and a convex surface 35b. The connection surface 35a is connected to the rotation operation portion 38. The convex surface 35b protrudes toward the installation surface 1. The adjustable tip end 35 has a substantially circular outer shape when viewed from the height direction, and has a substantially plano-convex lens shape as a whole. The adjustable tip end 35 is attached to the rotation operation portion 38 such that the center of the adjustable tip end 35 when viewed from the height direction is located at a position substantially equal to the central axes of the screw portion 37 and the rotation operation portion 38. It should be noted that the shape of the adjustable tip end 35 is not limited.

When the user rotates the rotation operation portion 38, the rotation operation portion 38, the screw portion 37, and the adjustable tip end 35 are integrally rotated. In other words, the whole of the adjustable leg 32 is rotated, and the adjustable tip end 35 is moved along the height direction.

A diameter φ1 of the rotation operation portion 38 when viewed from the height direction is typically set to a size that makes it easier for the user to input a rotation operation. As a result of an experiment for calculating a diameter that makes it easier to input a rotation operation, numerical values of approximately 20 mm to approximately 80 mm were derived as a range for setting the diameter φ1. It should be noted that the diameter φ1 of the rotation operation portion 38 is not limited thereto and may be optionally designed. The diameter φ1 of the rotation operation portion 38 corresponds to a first diameter.

A contact area S1 of the adjustable tip end 35 abutting on the installation surface 1 (where the size in the X direction is assumed as a contact area for convenience) is appropriately set on the basis of a support force to support the main body 10 and rotation operability of the adjustable leg 32. If the contact area S1 is large, the main body 10 can be stably supported, but resistance when the adjustable leg 32 is rotated is increased. If the contact area S1 is small, the adjustable leg 32 can be easily rotated, but force to support the main body 10 is weakened.

In view of the above points, the contact area S1 may be appropriately designed such that a desired support force and operability are exerted. It should be noted that the contact area S1 can be adjusted by appropriately designing the shape of the adjustable tip end 35, or the like.

Further, it is also possible to adjust the support force and operability of the adjustable leg 32 by focusing on hardness, a friction coefficient, or the like of the adjustable tip end 35. For example, if a material of the adjustable tip end 35 is appropriately selected, the hardness, the friction coefficient, or the like of the adjustable tip end 35 can be appropriately set.

For example, “Hytrel” (trademark) manufactured by DU PONT-TORAY CO., LTD., or the like is used as the adjustable tip end 35. In addition, among elastic members such as rubber, silicon, and thermoplastic elastomer, resin materials such as plastic, and the like, a material having relatively high hardness is used. As a matter of course, the adjustable tip end 35 is not limited to the above. It should be noted that in this embodiment the contact area S1, the hardness, and the friction coefficient of the adjustable tip end 35 correspond to a first contact area, a first hardness, and a first friction coefficient, respectively.

It should be noted that a configuration of the fixed leg 31 is substantially equal to the configuration of the adjustable leg 32 shown in FIG. 5A except that the position of the fixed tip end 34 is fixed. For example, a shaft portion is formed instead of the screw portion 37 and is fixed in a state of being inserted into the bottom surface 11c. A shape, a material, or the like of the fixed tip end 34 is set to be substantially equal to that of the adjustable tip end 35. As a matter of course, the fixed leg 31 may have a configuration different from that of the adjustable leg 32.

As shown in FIG. 5B, the rattling prevention leg 33 includes a screw portion 40, a rotation operation portion (second rotation operation portion) 41, and the rattling prevention tip end 36. The screw portion 40 has a substantially columnar shape and has a side surface 40a on which a screw groove (not shown in the figure) is formed. Screw holes are formed at the ends 17a of the front part 17 of the main body 10, and the screw portion 40 is attached to the screw hole by screwing.

The screw holes formed at the ends 17a of the front part 17 of the main body 10 correspond to a holding-leg holding unit that holds the rattling prevention legs 33 to be movable from the main body 10 toward the installation surface 1.

The rotation operation portion 41 has a substantially columnar shape extending in the height direction, and the screw portion 40 is connected to substantially the center thereof on the upper side (the main body 10 side). A side surface 41a of the rotation operation portion 41 includes a plurality of grooves 42 extending in the height direction. This improves operability when the rotation operation portion 41 is rotated.

The rattling prevention tip end 36 is provided on the lower side (the installation surface 1 side) of the rotation operation portion 41. The rotation operation portion 41 and the rattling prevention tip end 36 may be integrally formed.

As shown in FIG. 5B, the rattling prevention tip end 36 has a substantially columnar shape extending in the height direction and has a top surface 36a and a bottom surface 36b, both of which are flat. The top surface 36a is connected to the rotation operation portion 41, and the bottom surface 36b is caused to abut on the installation surface 1.

When the user rotates the rotation operation portion 41, the rotation operation portion 41, the screw portion 40, and the rattling prevention tip end 36 are integrally rotated. In other words, the whole of the rattling prevention leg 33 is rotated, and the rattling prevention tip end 36 is moved along the height direction.

A diameter φ2 of the rotation operation portion 41 when viewed from the height direction is typically set to a size that makes it slightly difficult for the user to input a rotation operation, that is, a relatively small value. Therefore, the operability of the rattling prevention leg 33 is slightly reduced when rotating. Differently from the adjustable leg 32, the rattling prevention leg 33 does not need fine height control and only needs to cause the rattling prevention tip end 36 to abut on the installation surface 1. Therefore, there is no problem even if the operability in rotation is reduced.

Further, setting the diameter φ2 of the rotation operation portion 41 to be relatively small can prevent an extra torque (rotation force) from being applied by the user after the rattling prevention tip end 36 abuts on the installation surface 1, because the small diameter φ2 makes it difficult for the user to rotate the rotation operation portion 41. This can prevent the rattling prevention leg 33 from being rotated more than necessary or being displaced after the rattling prevention leg 33 abuts on the installation surface 1. As a result, the position and the posture of the main body 10 that are determined by the fixed leg 31 and the adjustable legs 32 can be held with high accuracy.

The diameter φ2 of the rotation operation portion 41 is set to a range of, for example, approximately 20 mm to approximately 60 mm. As a matter of course, the range is not limited to the above, but is set to be smaller than at least the diameter φ1 of the rotation operation portion 38 of the adjustable leg 32. It should be noted that the diameter φ2 of the rotation operation portion 41 corresponds to a second diameter.

It should be noted that a configuration in which grooves are not formed on the side surface 41a of the rotation operation portion 41 may be provided in order to reduce rotation operability of the rattling prevention leg 33.

A contact area S2 of the rattling prevention tip end 36 abutting on the installation surface 1, and hardness and a friction coefficient of the rattling prevention tip end 36 are set such that a holding force to hold the position and the posture of the main body 10 are highly exerted. For example, the rattling prevention tip end 36 is formed of a material having low hardness and a high friction coefficient so as to increase the contact area S2. This enables the bottom surface 36b of the rattling prevention tip end 36 to sufficiently come into close contact with the installation surface 1 according to the inclination or shape of the installation surface 1.

With this configuration, it is possible to sufficiently prevent a positional displacement due to an external force in the horizontal direction or the like, and rattling or the like due to an external force in the vertical direction or the like from occurring, and to sufficiently hold the position and the posture of the main body 10. In particular, in this embodiment, the rattling prevention legs 33 are provided at the ends 17a of the main body 10 on the front side. In other words, since the rattling prevention legs 33 are provided at positions where rattling is likely to occur with respect to the three points of the fixed leg 31 and the adjustable legs 32, effects thereof will be sufficiently exerted.

Further, causing the rattling prevention tip ends 36 to come into close contact with the installation surface 1 can prevent the rattling prevention legs 33 from unnecessarily rotating after abutting on the installation surface 1. For example, in a case where the rattling prevention tip ends 36 are formed of a soft material, minor deformation thereof or the like that do not have any influence on the position or posture can absorb the torque.

The size of the contact area S2 of the rattling prevention tip end 36 is not limited, but is set to be larger than at least the contact area S1 of the adjustable leg 32.

Further, in this embodiment, the hardness of the rattling prevention tip end 36 is set to be smaller than the hardness of the adjustable tip end 35. Further, the friction coefficient of the rattling prevention tip end 36 is set to be larger than the friction coefficient of the adjustable tip end 35. With this configuration, each role of the adjustable leg 32 and the rattling prevention leg 33 is effectively exerted.

As described above, in this embodiment, the configuration of the fixed leg 31 is substantially equal to the configuration of the adjustable leg 32. Therefore, in this embodiment, the contact area S2 of the rattling prevention tip end 36 is set to be larger than the contact area of the fixed tip end 34. Further, the hardness of the rattling prevention tip end 36 is set to be lower than the hardness of the fixed tip end 34. Furthermore, the friction coefficient of the rattling prevention tip end 36 is set to be larger than the friction coefficient of the fixed tip end 34.

For example, “PORON” (trademark) manufactured by INOAC CORPORATION is used as the rattling prevention tip end 36. In addition, among elastic members such as rubber, and resin materials such as polyurethane, and the like, a material having relatively low hardness is used. For example, a material having Shore A hardness of approximately 10 to approximately 40 is used. As a matter of course, the rattling prevention tip end 36 is not limited to the above.

In this embodiment, the plurality of rattling prevention legs 33 function as a holding unit. Further, the rattling prevention leg 33 and the rattling prevention tip end 36 correspond to a holding leg and a holding tip end, respectively. Further, the contact area S2, the hardness, and the friction coefficient of the rattling prevention tip end 36 correspond to a second contact area, a second hardness, and a second friction coefficient, respectively.

As described above, in the image display apparatus 100 according to this embodiment, a predetermined position and a predetermined posture are achieved by the fixed leg 31 and the adjustable legs 32. Further, the position and the posture are held by the rattling prevention legs 33 that are movable toward the installation surface 1. With this configuration, it is possible to sufficiently prevent rattling or a positional displacement of the image display apparatus 100 from occurring.

In the ultra-short focus projector, the angle of projection is extreme, and variation in size of a lens to be mounted is large. Therefore, depending on a projection environment including an installation position of the projector, a position of a carriage or the like on which the projector is placed, or a position of a screen or the like, a projected image may be moved, or an image distortion by which the projected image is deformed may occur. The position and the posture of the projector are adjusted in order to adjust the image distortion or the like. However, change with time or the like due to a minute external force, vibrations, or the like after the adjustment is made leads to a displacement of the projector, and the adjustment is repeatedly performed in many cases.

In the image display apparatus 100 according to this embodiment, the rattling prevention legs 33 are operated after the position and the posture of the main body 10 are adjusted, so that the adjusted position and posture can be sufficiently held. Therefore, the instability of the position and posture due to an external force, change with time, or the like can be sufficiently prevented from occurring, and repeated adjustments become unnecessary.

Further, in order to project an image with a wide angle of view, many short focus projectors having a transversely long shape have been developed. In a case of the transversely long shape, the degree of stability provided by only three points, i.e., one point at the center on the front side and two ends on the rear side, is low with respect to force in the vertical direction. As in this embodiment, providing the rattling prevention legs at the two ends on the front side can sufficiently prevent a positional displacement or rattling of the short focus projector having a transversely long shape from occurring.

### Other Embodiments

The present technology is not limited to the embodiment described above, and various other embodiments can be achieved.

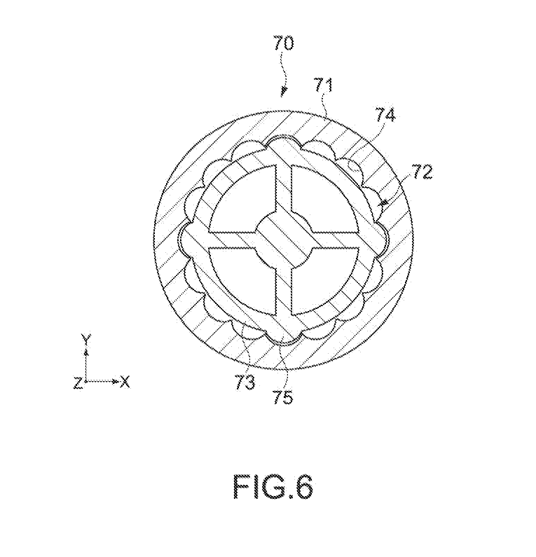

FIG. 6 is a cross-sectional view showing a configuration example of a rattling prevention leg according to another embodiment. Here, FIG. 6 shows a cross-sectional view of a rotation operation portion 71 of a rattling prevention leg 70 taken along a horizontal direction. The rattling prevention leg 70 includes a regulation mechanism 72 that regulates rotation of the rattling prevention leg 70 when a torque applied to the rotation operation portion 71 is a predetermined threshold value or larger.

As shown in FIG. 6, the rattling prevention leg 70 includes the rotation operation portion 71 having a cylindrical shape and a rotary drive portion 73 provided inside the rotation operation portion 71. On an inner circumferential surface of the rotation operation portion 71, a plurality of grooves 74 extending in the Z direction are formed so as to be arranged along a circumferential direction. Each of the grooves 74 has a curved surface shape when viewed from the Z direction.

On an outer circumferential surface of the rotary drive portion 73, four protrusions 75 are formed at intervals of approximately 90 degrees. The protrusions 75 extend in the Z direction, and each shape thereof when viewed from the Z direction is substantially equal to the shape of the groove 74. Further, the protrusions 75 are connected to a screw portion and a rattling prevention tip end of the rattling prevention leg 70. Therefore, when the rotary drive portion 73 is rotated, the rotary drive portion 73, the screw portion, and the rattling prevention tip end are integrally rotated.

As shown in FIG. 6, the four protrusions 75 of the rotary drive portion 73 are fitted into the respective grooves 74 of the rotation operation portion 71. When the user rotates the rotation operation portion 71, the rotary drive portion 73 also rotates accordingly. Therefore, the screw portion and the rattling prevention tip end also rotate, and the length of the rattling prevention leg 70 changes.

When the rattling prevention tip end abuts on the installation surface, the rotation of the rotary drive portion 73 and the rotation operation portion 71 is stopped. When the user further inputs a rotation operation in such a state, a torque applied to the rotation operation portion 71 is increased. When the torque exceeds a threshold value, the fit between the grooves 74 of the rotation operation portion 71 and the protrusions 75 of the rotary drive portion 73 is released. With this configuration, the rotation operation portion 71 spins free, and the rotation of the rattling prevention leg 70 is regulated. As a result, it is possible to prevent the rattling prevention tip end from being rotated more than necessary and prevent the position and the posture of the main body from being made unstable.

In this embodiment, the regulation mechanism 72 is achieved by the plurality of grooves 74 of the rotation operation portion 71, the protrusions 75 of the rotary drive portion 73, and the like. The configuration of the regulation mechanism 72 is not limited, and an optional gear mechanism or clutch mechanism may be used therefor.

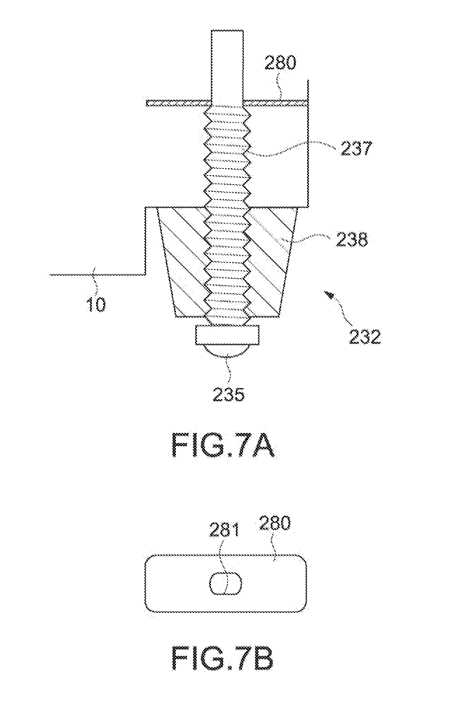

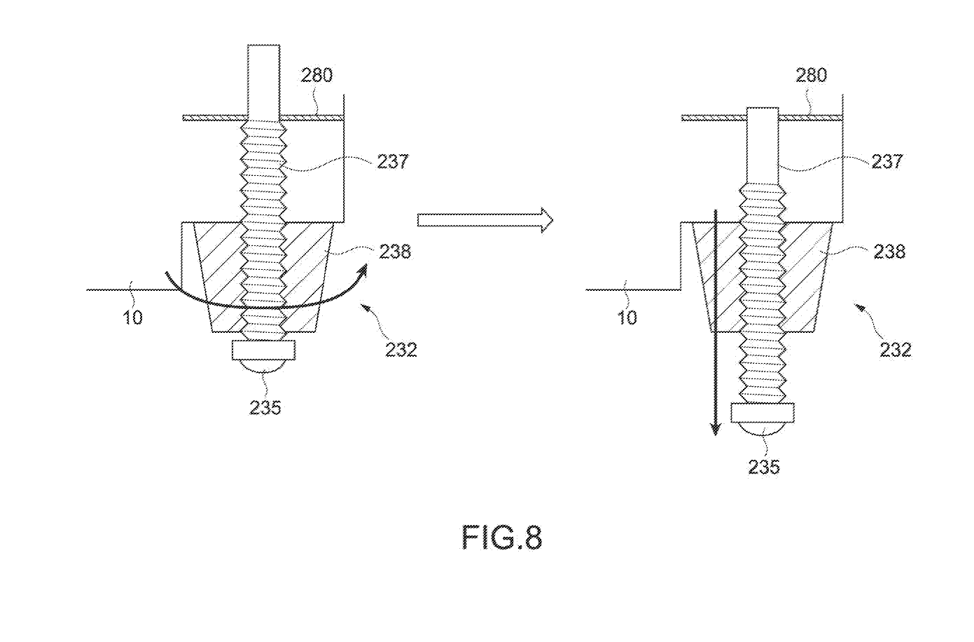

FIGS. 7A, 7B, and 8 are schematic views each showing a configuration example of an adjustable leg according to another embodiment. An adjustable leg 232 includes a screw portion 237 (first holding unit) and a first rotation operation portion 238 (second holding unit). The screw portion 237 holds an adjustable tip end 235. The first rotation operation portion 238 holds the screw portion 237 so as to be movable from the main body 10 to the installation surface. Further, the adjustable leg 232 includes a rotation regulation portion 280 that regulates the rotation of the screw portion 237.

The first rotation operation portion 238 is rotatably attached to the bottom surface of the main body 10. Further, the first rotation operation portion 238 is attached so as not to fall down from the bottom surface of the main body 10. For example, a locking member (not shown in the figure), which is rotatably disposed inside the main body 10, and the first rotation operation portion 238 are coupled to each other so as to sandwich the bottom surface. When the first rotation operation portion 238 rotates, the inside locking member also integrally rotates.

As shown in FIG. 7A, the screw portion 237 is screwed into a screw hole formed in the first rotation operation portion 238 and the main body 10. In other words, the first rotation operation portion 238 holds the screw portion 237 by screwing. An end of the screw portion 237 on the opposite side of the adjustable tip end 235 is inserted into the rotation regulation portion 280 fixed to the inside of the main body 10. As shown in FIG. 7B, the rotation regulation portion 280 includes an elliptically shaped hole 281. The end of the screw portion 237, which has a cross section substantially equal to the shape of the hole 281, is inserted into the hole 281. With this configuration, the rotation of the screw portion 237 is regulated.

As shown in FIG. 8, when the first rotation operation portion 238 rotates, the screw portion 237, the rotation of which is regulated, moves along a direction from the main body 10 toward the installation surface. In this embodiment, when the first rotation operation portion 238 is rotated in a clockwise direction, the screw portion 237 moves toward the main body 10. When the first rotation operation portion 238 is rotated in a counterclockwise direction, the screw portion 237 moves toward the installation surface. As a matter of course, the rotation direction is not limited.

The configuration shown in FIGS. 7A, 7B, and 8 can also be applied to the rattling prevention leg. In this case, the screw portion 237 functions as a third holding unit. A part corresponding to the first rotation operation portion 238 is a second rotation operation portion (fourth holding unit). If the diameter of the second rotation operation portion is made smaller than that of the first rotation operation portion, the effects described above are exerted.

In both cases where the configuration shown in FIGS. 5A and 5B is employed and where the configuration shown in FIGS. 7A, 7B, and 8 is employed, the adjustable leg and the rattling prevention leg can be achieved with a simple configuration.

The installation positions and the installation number of fixed legs, adjustable legs, and rattling prevention legs, and the like are not limited and may be optionally designed. For example, a position where each leg is attached is set on the basis of a position of the projection window of the main body, an image projecting direction, or the like. For example, it may be possible to provide the adjustable legs on the front side and provide the fixed leg and the rattling prevention legs on the rear side. Alternatively, assuming that the projection window is provided at a position closer to the right side or the left side, in that case, it may be possible to provide the adjustable legs on the side on which the projection window is provided, and provide the fixed leg and the rattling prevention legs on the opposite side. Alternatively, the rattling prevention leg may be provided at the center of the bottom surface.

In the above description, the following conditions A to D are satisfied for the adjustable tip end and the rattling prevention tip end.

Condition A (hardness) . . . Adjustable tip end>Rattling prevention tip end
Condition B (contact area) . . . Adjustable tip end<Rattling prevention tip end
Condition C (friction coefficient) . . . Adjustable tip end<Rattling prevention tip end
Condition D (diameter of rotation operation portion) . . . Adjustable tip end>Rattling prevention tip end

The present technology is not limited to the case where those conditions A to D are always satisfied and, for example, any of the conditions may be satisfied. Alternatively, a leg having the same configuration as the adjustable leg may be used as the rattling prevention leg. In this case, all the conditions A to D are equal to one another.

As described above, the screw holes to which the adjustable legs 32 and the rattling prevention legs 33 are attached are formed in the bottom surface 11c shown in FIG. 3. Those screw holes may also be used for attaching ceiling hangers to the bottom surface 11c of the main body 10. For example, in a case where the image display apparatus 100 is attached to a ceiling or the like, the main body 10 is turned upside down. Then the adjustable legs 32 and the rattling prevention legs 33 at the four corners of the bottom surface 11c are removed.

The ceiling hangers are disposed so as to be aligned with the screw holes to which the adjustable legs 32 and the rattling prevention legs 33 have been attached, and then screwed. It should be noted that a screw hole may also be formed at a position other than the four corners of the bottom surface 11c, for example, a position close to the center of gravity of the main body 10, and a screw may be attached to the screw hole as well. With this configuration, the main body can be stably supported.

Connecting the ceiling hangers, which are attached to the bottom surface 11c, to connection brackets provided to the ceiling or the like can easily attach the image display apparatus 100 to the ceiling or the like. It should be noted that a specific configuration of the ceiling hanger, the connection bracket, or the like is not limited and, for example, the posture or the like of the main body 10 may be configured to be adjustable. In such a manner, if the screw holes for the adjustable legs 32 and the rattling prevention legs 33 are shared, the number of screw holes can be prevented from increasing. For example, if the screw holes formed for the ceiling hangers are used as the screw holes for the rattling prevention legs 33 according to the present technology, it is unnecessary to newly form the screw holes for the rattling prevention legs 33. As a result, for example, design changes become unnecessary, and costs or the like can be reduced.

In the above description, the screw mechanism is provided, and the length of each of the adjustable leg and the rattling prevention leg is adjusted by rotation. The present technology is not limited to the above, and the adjustable leg and the rattling prevention leg may be linearly movable in accordance with push-in/pull-up in the height direction. In this case, a stopper mechanism with which each leg is fixed at an adjusted length or the like is appropriately formed.

Further, the length of the adjustable leg or the fixed leg may be adjusted by electrical control. For example, a length control unit constituted of a motor, a gear mechanism, or the like is provided to the main body. The length of the adjustable leg and the length of the rattling prevention leg are adjusted by a switch operation or the like of the user. This makes it easy to adjust the posture and set the rattling prevention leg, for example. It should be noted that a mechanism to detect that the rattling prevention leg abuts on the installation surface and then regulate an extension of the rattling prevention leg may be provided. This can prevent the main body from moving after the posture or the like is adjusted.

The configuration of the support unit that supports the main body so as to obtain a predetermined position and posture is not limited. For example, the support unit may be constituted only of a fixed leg, the position of the tip end of which is fixed to the bottom surface. Alternatively, the support unit may be constituted only of an adjustable leg, the tip end of which is movable to the bottom surface. Further, the configuration to be a leg portion is not limited, and a protrusion extending downward may be formed in a predetermined part of the bottom surface. For example, the support unit may be constituted of a protrusion formed over substantially the entire circumference of the bottom surface.

In a case where there is no adjustable leg that can adjust the posture or the like, the posture of the main body is fixed. Also in this case, when the rattling prevention leg is moved and caused to abut on the installation surface, the posture can be held.

The ultra-short focus projector has been described above as an example, but the present technology can be applied to a projector having an optional type. Further, the present technology can also be applied to an image display apparatus other than the projector.

It is also possible to combine, among the features of the present technology described above, at least two of the features. In other words, various features described in each embodiment may be optionally combined without distinction of embodiments. Further, the various effects described above are merely illustrative and not restrictive. Furthermore, other effects may be produced.

It should be noted that the present technology can also have the following configurations.

(1)

An image display apparatus, including:
a main body that projects an image;
a support unit that abuts on an installation surface on which the main body is installed, and supports the main body such that the main body takes a predetermined posture with respect to the installation surface; and
a holding unit that is provided at a position different from a positon of the support unit on the main body, and abuts on the installation surface to hold the posture of the main body supported by the support unit.
   (2)

The image display apparatus according to (1), in which
the support unit supports the main body such that the main body is located at a predetermined position with respect to the installation surface, and
the holding unit holds the position of the main body supported by the support unit.
   (3)

The image display apparatus according to (1) or (2), in which the holding unit is configured to be movable from the main body toward the installation surface.

(4)

The image display apparatus according to any one of (1) to (3), in which
the support unit includes a fixed leg and an adjustable leg, the fixed leg including a fixed tip end at a fixed distance from the main body, the adjustable leg including an adjustable tip end that is movable from the main body toward the installation surface, and
the holding unit includes a holding leg, the holding leg including a holding tip end that is movable from the main body toward the installation surface.
   (5)

The image display apparatus according to (4), in which
the adjustable tip end has a first hardness, and
the holding tip end has a second hardness that is lower than the first hardness.
   (6)

The image display apparatus according to (5), in which
the second hardness is lower than a hardness of the fixed tip end.
   (7)

The image display apparatus according to any one of (4) to (6), in which
the adjustable tip end abuts on the installation surface to have a first contact area, and
the holding tip end abuts on the installation surface to have a second contact area that is larger than the first contact area.
   (8)

The image display apparatus according to any one of (4) to (7), in which
the adjustable tip end has a convex surface that abuts on the installation surface, and
the holding tip end has a flat surface that abuts on the installation surface.
   (9)

The image display apparatus according to any one of (4) to (8), in which
the adjustable tip end has a first friction coefficient, and
the holding tip end has a second friction coefficient that is larger than the first friction coefficient.
   (10)

The image display apparatus according to any one of (4) to (9), in which
the adjustable leg includes a first rotation operation portion that rotates to move the adjustable tip end, and
the holding leg includes a second rotation operation portion that rotates to move the holding tip end.
   (11)

The image display apparatus according to (10), in which
the first rotation operation portion has a first diameter, and
the second rotation operation portion has a second diameter that is smaller than the first diameter.
   (12)

The image display apparatus according to any one of (4) to (11), in which
the adjustable leg includes a first holding unit and a second holding unit, the first holding unit holding the adjustable tip end, the second holding unit holding the first holding unit to be movable from the main body toward the installation surface, and
the holding leg includes a third holding unit and a fourth holding unit, the third holding unit holding the holding tip end, the fourth holding unit holding the third holding unit to be movable from the main body toward the installation surface.
   (13)

The image display apparatus according to (12), in which
the second holding unit rotates to move the first holding unit, and
the fourth holding unit rotates to move the third holding unit.
   (14)

The image display apparatus according to (13), in which
the second holding unit has a first diameter, and
the fourth holding unit has a second diameter that is smaller than the first diameter.
   (15)

The image display apparatus according to any one of (12) to (14), in which
the second holding unit holds the first holding unit by screwing, and
the fourth holding unit holds the third holding unit by screwing.
   (16)

The image display apparatus according to any one of (4) to (11), in which
the main body includes an adjustable-leg holding unit and a holding-leg holding unit, the adjustable-leg holding unit holding the adjustable leg to be movable from the main body toward the installation surface, the holding-leg holding unit holding the holding leg to be movable from the main body toward the installation surface.
   (17)

The image display apparatus according to (16), in which
the adjustable-leg holding unit holds the adjustable leg by screwing, and
the holding-leg holding unit holds the holding leg by screwing.
   (18)

The image display apparatus according to any one of (1) to (17), further including
a short focus optical system that is housed in the main body and is capable of projecting the image.
   (19)

The image display apparatus according to any one of (4) to (18), in which
when the image is projected on a front side and the other side is considered as a rear side,
the fixed leg is provided at one point of a substantially center portion of the main body on the front side,
the adjustable leg is provided at each of two ends of the main body on the rear side, and
the holding leg is provided at each of two ends of the main body on the front side.
   (20)

The image display apparatus according to (10) or (11), in which
the holding leg includes a regulation mechanism that regulates rotation of the holding leg when a torque applied to the second rotation operation portion is a predetermined threshold value or larger.
   (21)

A projector, including
a main body from which an image is projected onto a projection surface;
at least one main support that extends from the main body and at least partially carries a weight of the projector to a support surface and holds the main body at a predetermined posture with respect to the support surface and the projection surface; and
at least one stability support that extends from the main body to the support surface, the at least one stability support being laterally displaced from the at least one main support structure so as to retain the main body at the predetermined posture when the main body is exposed to a mechanical disturbance.
   (22)

The projector according to (21), wherein
the at least one stability support supports the main body such that the main body is located at a predetermined position with respect to the support surface, and
at least one stability support holds the position of the main body supported by the at least one main support.
   (23)

The projector according to (21), wherein
at least one stability support is configured to extend/retract by a controllable amount in a direction from the main body toward the support surface.
   (24)

The projector according to (21), wherein
the at least one main support includes a fixed leg and an adjustable leg, the fixed leg including a fixed tip end at a fixed distance from the main body, the adjustable leg including an adjustable tip end that is movable from the main body toward the support surface, and
the at least one stability support includes a holding leg, the holding leg including a holding tip end that is movable from the main body toward the support surface.
   (25)

The projector according to (24), wherein
the adjustable tip end has a first hardness, and
the holding tip end has a second hardness that is lower than the first hardness.
   (26)

The projector according to (25), wherein
the second hardness is lower than a hardness of the fixed tip end.
   (27)

The projector according to (24), wherein
the adjustable tip end abuts the support surface at a first contact area, and
the holding tip end abuts the support surface at a second contact area that is larger than the first contact area.
   (28)

The projector according to (24), wherein
the adjustable tip end has a convex surface that abuts the support surface, and
the holding tip end has a flat surface that abuts on the support surface.
   (29)

The projector according to (24), wherein
the adjustable tip end has a first friction coefficient, and
the holding tip end has a second friction coefficient that is larger than the first friction coefficient.
   (30)

The projector according to (24), wherein
the adjustable leg includes a first rotation portion that rotates to extend the adjustable tip end, and
the holding leg includes a second rotation portion that rotates to extend the holding tip end.
   (31)

The projector according to (30), wherein
the first rotation portion has a first diameter, and
the second rotation portion has a second diameter that is smaller than the first diameter.
   (32)

The projector according to (24), wherein
the adjustable leg includes a first holding member and a second holding member, the first holding member holds the adjustable tip end, the second holding member holds the first holding member while the adjustable tip end is moved toward the support surface, and
the holding leg includes a third holding member and a fourth holding member, the third holding member holds the holding tip end, the fourth holding member holds the third holding member when the holding tip end is moved from the main body toward the support surface.
   (33)

The projector according to (32), wherein
the second holding member is rotatable so as to extend the first holding member, and
the fourth holding member is rotatable so as to move the third holding member.
   (34)

The projector according to (33), wherein
the second holding member has a first diameter, and
the fourth holding member has a second diameter that is smaller than the first diameter.
   (35)

The projector according to (32), wherein
the second holding member frictionally holds the first holding member by screw threads received by the second holding member, and
the fourth holding member frictionally holds the third holding member by screw threads received by the fourth holding member.
   (36)

The projector according to (24), wherein
the main body includes an adjustable-leg holding unit and a holding-leg holding unit, the adjustable-leg holding unit holding the adjustable leg to be movable from the main body toward the support surface, the holding-leg holding unit holding the holding leg to be movable from the main body toward the support surface.
   (37)

The projector according to (21), further comprising:
a short throw optical system that is housed in the main body and configured to project the image.
   (38)

The projector according to (24), wherein
when the image is projected toward a front side of the main body, the fixed leg is provided at one point of a substantially center portion of the main body on the front side,
the adjustable leg is provided at each of two ends of the main body on a rear side of the opposite main body, and
the holding leg is provided at each of two ends of the main body on the front side.
   (39)

The projector according to (30), wherein
the holding leg includes a regulation mechanism that regulates rotation of the holding leg when a torque applied to the second rotation portion is a predetermined threshold value or larger.
   (40)

A method of installing a projector, comprising:
supporting a main body from which an image is projected onto a projection surface by at least one main support, said supporting including at least partially carrying a weight of the projector to a support surface and holding the main body at a predetermined posture with respect to the support surface and the projection surface; and
holding the posture of the main body with at least one stability support that extends from the main body to the support surface, the at least one stability support being laterally displaced from the at least one main support structure, said holding including retaining the main body at the predetermined posture when the main body is exposed to a mechanical disturbance.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

φ1 first diameter
φ2 second diameter
S1 first contact area
S2 second contact area
10 main body
14 projection optical system
17 front part
18 rear part
30 support mechanism
fixed leg
32, 232 adjustable leg
33 rattling prevention leg
34 fixed tip end
35, 235 adjustable tip end
36, 70 rattling prevention tip end
38, 238 first rotation operation portion
41, 71 second rotation operation portion
72 regulation mechanism
100 image display apparatus

1. A projector, comprising:
a main body from which an image is projected onto a projection surface;
at least one main support that extends from the main body and at least partially carries a weight of the projector to a support surface and holds the main body at a predetermined posture with respect to the support surface and the projection surface; and
at least one stability support that extends from the main body to the support surface, the at least one stability support being laterally displaced from the at least one main support structure so as to retain the main body at the predetermined posture when the main body is exposed to a mechanical disturbance.

2. The projector according to claim 1, wherein
the at least one stability support supports the main body such that the main body is located at a predetermined position with respect to the support surface, and
at least one stability support holds the position of the main body supported by the at least one main support.

3. The projector according to claim 1, wherein
at least one stability support is configured to extend and/or retract by a controllable amount in a direction from the main body toward the support surface.

4. The projector according to claim 1, wherein
the at least one main support includes a fixed leg and an adjustable leg, the fixed leg including a fixed tip end at a fixed distance from the main body, the adjustable leg including an adjustable tip end that is movable from the main body toward the support surface, and
the at least one stability support includes a holding leg, the holding leg including a holding tip end that is movable from the main body toward the support surface.

5. The projector according to claim 4, wherein
the adjustable tip end has a first hardness, and
the holding tip end has a second hardness that is lower than the first hardness.

6. The projector according to claim 5, wherein
the second hardness is lower than a hardness of the fixed tip end.

7. The projector according to claim 4, wherein
the adjustable tip end abuts the support surface at a first contact area, and
the holding tip end abuts the support surface at a second contact area that is larger than the first contact area.

8. The projector according to claim 4, wherein
the adjustable tip end has a convex surface that abuts the support surface, and
the holding tip end has a flat surface that abuts on the support surface.

9. The projector according to claim 4, wherein
the adjustable tip end has a first friction coefficient, and
the holding tip end has a second friction coefficient that is larger than the first friction coefficient.

10. The projector according to claim 4, wherein
the adjustable leg includes a first rotation portion that rotates to extend the adjustable tip end, and
the holding leg includes a second rotation portion that rotates to extend the holding tip end.

11. The projector according to claim 10, wherein
the first rotation portion has a first diameter, and
the second rotation portion has a second diameter that is smaller than the first diameter.

12. The projector according to claim 4, wherein
the adjustable leg includes a first holding member and a second holding member, the first holding member holds the adjustable tip end, the second holding member holds the first holding member while the adjustable tip end is moved toward the support surface, and
the holding leg includes a third holding member and a fourth holding member, the third holding member holds the holding tip end, the fourth holding member holds the third holding member when the holding tip end is moved from the main body toward the support surface.

13. The projector according to claim 12, wherein
the second holding member is rotatable so as to extend the first holding member, and
the fourth holding member is rotatable so as to move the third holding member.

14. The projector according to claim 13, wherein
the second holding member has a first diameter, and
the fourth holding member has a second diameter that is smaller than the first diameter.

15. The projector according to claim 12, wherein
the second holding member frictionally holds the first holding member by screw threads received by the second holding member, and
the fourth holding member frictionally holds the third holding member by screw threads received by the fourth holding member.

16. The projector according to claim 4, wherein
the main body includes an adjustable-leg holding unit and a holding-leg holding unit, the adjustable-leg holding unit holding the adjustable leg to be movable from the main body toward the support surface, the holding-leg holding unit holding the holding leg to be movable from the main body toward the support surface.

17. The projector according to claim 1, further comprising:
a short throw optical system that is housed in the main body and configured to project the image.

18. The projector according to claim 4, wherein
when the image is projected toward a front side of the main body, the fixed leg is provided at one point of a substantially center portion of the main body on the front side,
the adjustable leg is provided at each of two ends of the main body on a rear side of the opposite main body, and
the holding leg is provided at each of two ends of the main body on the front side.

19. The projector according to claim 10, wherein
the holding leg includes a regulation mechanism that regulates rotation of the holding leg when a torque applied to the second rotation portion is a predetermined threshold value or larger.

20. A method of installing a projector, comprising:
supporting a main body from which an image is projected onto a projection surface by at least one main support, said supporting including at least partially carrying a weight of the projector to a support surface and holding the main body at a predetermined posture with respect to the support surface and the projection surface; and
holding the posture of the main body with at least one stability support that extends from the main body to the support surface, the at least one stability support being laterally displaced from the at least one main support structure, said holding including retaining the main body at the predetermined posture when the main body is exposed to a mechanical disturbance.
